(19) United States
(12) Patent Application Publication
(10) Pub. No.: US 2013/0252222 A1
(43) Pub. Date: Sep. 26, 2013

(54) SYSTEMS AND METHODS FOR REAL-TIME AND DISCRETE ANALYTICS FOR WEB-MEDIATED CONTENT AND EVENTS

(71) Applicants: Steven Fox, Kirkland, WA (US); Paul Stubbs, Redmond, WA (US); Chris Garrison, Bellevue, WA (US)

(72) Inventors: Steven Fox, Kirkland, WA (US); Paul Stubbs, Redmond, WA (US); Chris Garrison, Bellevue, WA (US)

(21) Appl. No.: 13/850,857

(22) Filed: Mar. 26, 2013

Related U.S. Application Data
(60) Provisional application No. 61/671,045, filed on Jul. 12, 2012.
(60) Provisional application No. 61/615,845, filed on Mar. 26, 2012.

(51) Int. Cl. G09B 7/00

(52) U.S. Cl. CPC G09B 7/00
USPC 434/350

(57) ABSTRACT

During a presentation, a question is emitted over a network connection to a plurality of audience members, who utilize a computing device to respond. Client software for the audience members' heterogeneous computing devices may receive questions and upload answers. Answers from the audience are collected and aggregated, including optionally aggregating demographic information associated with each respondent and the answer of the respondent. Real-time analytics are provided to the presenter, which facilitates formulation or selection of further content and/or further questions. The timing of the questions can be synchronized with a content by linking the question to particular portions of the content, by tying the question to a particular slide or frame, by setting a length of time after which the question should be emitted, by offering a question on-demand, or some other method. A website maintains content, questions, user credentials of audience members, responses, and aggregated data, among other aspects.

### PRIORITY CLAIM

This invention claims the benefit of U.S. provisional patent application Ser. No. 61/615,845 filed Mar. 26, 2012 (our ref. GARR-1-1001) and U.S. provisional patent application Ser. No. 61/671,045 filed Jul. 12, 2012 (our ref. GARR-1-1002). The foregoing applications are incorporated by reference in their entirety as if fully set forth herein.

### FIELD OF THE INVENTION

This invention relates generally to analytics, and more specifically, to systems and methods for real-time and discrete analytics for web-mediated content and events.

### SUMMARY

This invention relates generally to analytics, and more specifically, to systems and methods for real-time and discrete analytics for web-mediated content and events. In some embodiments, a method for real-time and discrete analytics for web-mediated content and events may be provided for the benefit of a presenter. In some embodiments, the presenter may be delivering a speech to a room full of audience members. In other embodiments, the presenter may be delivering a web-based media content over the Internet to audience members, the audience members being geographically dispersed but consuming the web-based media content being delivered by the presenter simultaneously. In some embodiments, the web-based media content may be delivered to the audience members via client software on a terminal, the terminal being any of a plurality of devices, which may include a laptop, a tablet, a smartphone, or any other device operably connected via a network connection to the one or more servers.

In some embodiments, a method for real-time and discrete analytics for web-mediated content and events may facilitate the emitting of questions to the audience members. In some embodiments, the emitting of questions may be controlled by the presenter. In other embodiments, the emitting of questions may be delivered by the one or more servers in synchronization with the presenter. In some embodiments, emitting a question results in the question being displayed on the plurality of client terminals, inviting the plurality of audience members to provide an answer, the answer being received via the network connection by the one or more servers.

In some embodiments, answers are stored as data by the one or more servers, and the data is aggregated. The aggregated data may be viewed by the presenter using a computing device. The presenter may formulate or select additional questions based upon the aggregated data being viewed on the computing device. In some embodiments, the computing device is also used to deliver a presentation to the audience members, such as a PowerPoint presentation. In other embodiments, the computing device may be used to control the timing and content of questions for the audience members.

In some embodiments, a system for real-time and discrete analytics for web-mediated content and events may include an authentication component, comprising the means for users of client devices to connect with the system; a storage component, comprising various data stores for authentication information, presentation information, question information, response information, aggregated data sets, analytics, or other data stored in conjunction with the system; an emitter component, comprising a means for a presenter or other operator of the system to emit a question which will be received by the client devices; and an analytics component, comprising a private dashboard which is displayed on a display. In some embodiments, the system may have a project component, comprising a means for users of the system to create a project file including a presentation and a plurality of questions to be emitted at certain times during the presentation.

### BRIEF DESCRIPTION OF THE DRAWINGS

Embodiments of the present invention are described in detail below with reference to the following drawings:

FIG. 1 is a block diagram of an exemplary environment in which a method for real-time and discrete analytics for web-mediated content and events may be implemented, in accordance with an embodiment of the invention;

FIG. 2 is a flow diagram depicting a method for real-time and discrete analytics for web-mediated content and events, in accordance with an embodiment of the invention;

FIGS. 3-6 are a flow diagram depicting alternative embodiments of a method for real-time and discrete analytics for web-mediated content and events; and

FIG. 7 is a block diagram of a system for real-time and discrete analytics for web-mediated content and events, in accordance with an embodiment of the invention.

### DETAILED DESCRIPTION

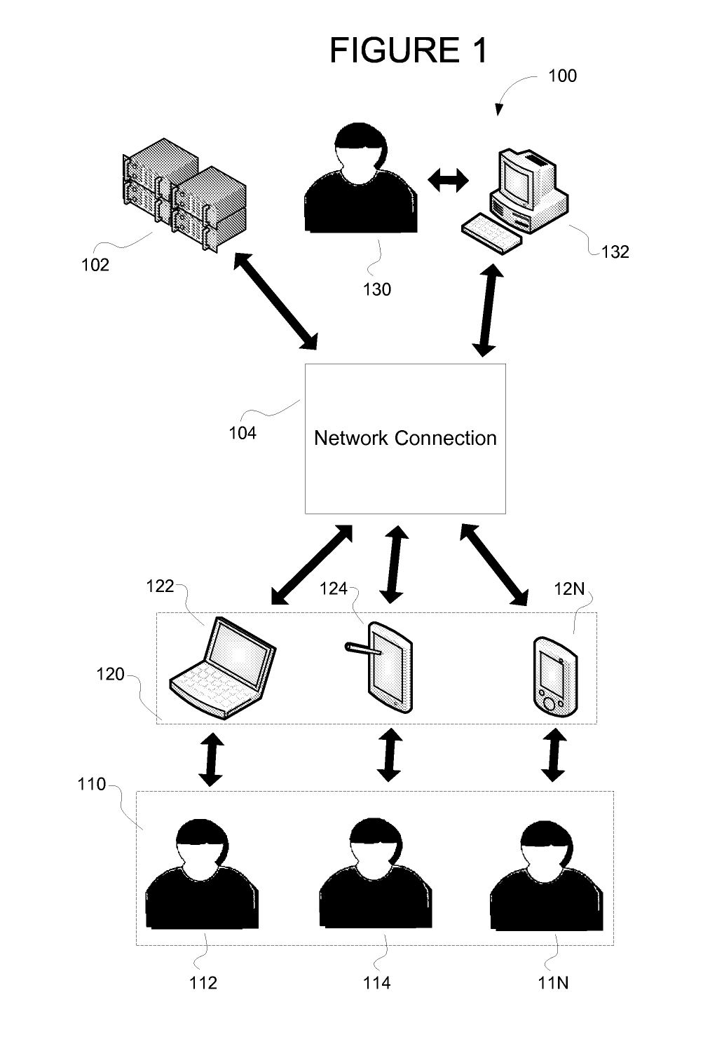

This invention relates generally to analytics, and more specifically, to systems and methods for real-time and discrete analytics for web-mediated content and events. Specific details of certain embodiments of the invention are set forth in the following description and FIGS. 1-7 to provide a thorough understanding of such embodiments. The present invention may have additional embodiments, may be practiced without one or more of the details described for any particular described embodiment, or may have any detail described for one particular embodiment practiced with any other detail described for another embodiment.

FIG. 1 is a block diagram of an exemplary environment in which a method for real-time and discrete analytics for web-mediated content and events may be implemented, in accordance with an embodiment of the invention. In some embodiments, a method for real-time and discrete analytics for web-mediated content and events may be facilitated by one or more servers 102. The one or more servers 102 may include one or more of a web front-end, a project site, a feedback engine, a real-time viewing engine, a reporting engine, a federation engine, and/or a database tier, the database tier having one or more of account information, billing information, and/or project information. The one or more servers are operatively coupled with a network connection 104. The network connection 104 provides connections between the servers, and also provides network connections to system clients.

In some embodiments, a method for real-time and discrete analytics for web-mediated content and events may be provided for the benefit of a presenter 130. In some embodiments, the presenter 130 may be delivering a speech to a room full of audience members 110. In other embodiments, the presenter 130 may be delivering a web-based media content over the Internet to audience members 110, the audience members 110 being geographically dispersed but consuming the web-based media content being delivered by the presenter 130 simultaneously. In some embodiments, the web-based media content may be delivered to the audience members 110 via client software on a terminal, the terminal being depicted as a plurality of devices 120, which may include a laptop 122, a tablet 124, a smartphone 12N, or any other device operably connected via a network connection to the one or more servers 102.

In some embodiments, a method for real-time and discrete analytics for web-mediated content and events may facilitate the emitting of questions to the audience members 110. In some embodiments, the emitting of questions may be controlled by the presenter 130. In other embodiments, the emitting of questions may be delivered by the one or more servers 102 in synchronization with the presenter 130. In some embodiments, emitting a question results in the question being displayed on the plurality of client terminals 120, inviting the plurality of audience members 110 to provide an answer, the answer being received via the network connection 104 by the one or more servers 102.

In some embodiments, answers are stored as data by the one or more servers 102, and the data is aggregated. The aggregated data may be viewed by the presenter 130 using a computing device 132. The presenter 130 may formulate or select additional questions based upon the aggregated data being viewed on the computing device 132. In some embodiments, the computing device 132 is also used to deliver a presentation to the audience members 110, such as a PowerPoint presentation. In other embodiments, the computing device 132 may be used to control the timing and content of questions for the audience members 110.

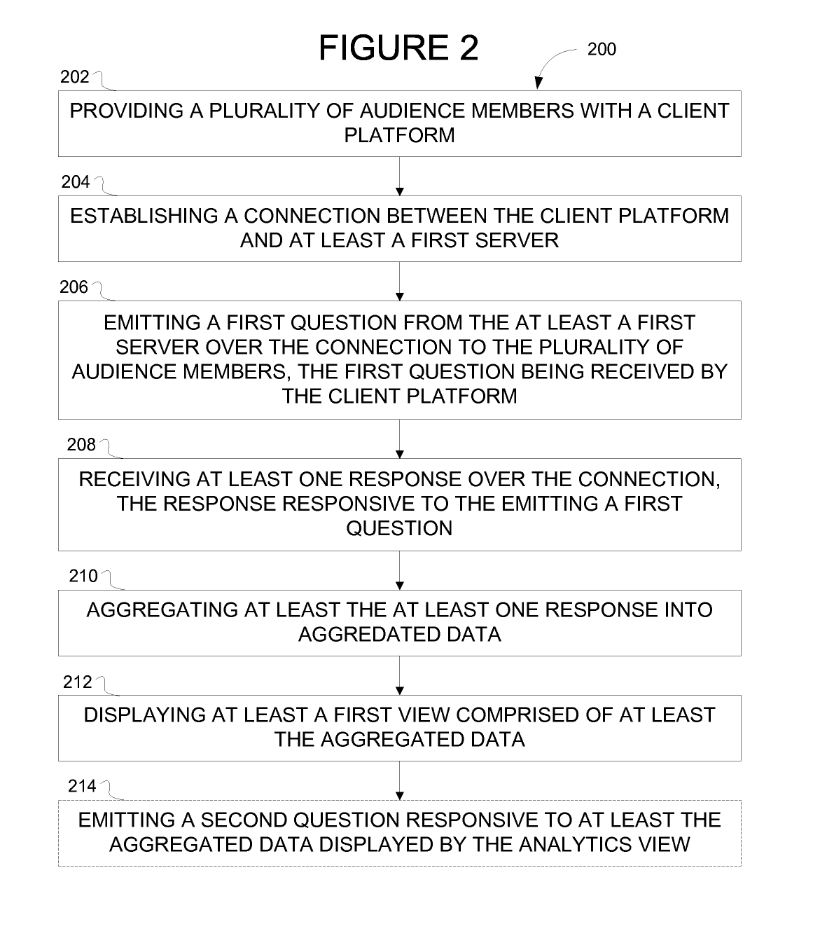

FIG. 2 is a flow diagram depicting a method for real-time and discrete analytics for web-mediated content and events, in accordance with an embodiment of the invention. In some embodiments, a method for real-time and discrete analytics for web-mediated content and events includes providing a plurality of audience members with a client platform at 202, establishing a connection between the client platform and at least a first server at 204, emitting a first question from the at least a first server over the connection to the plurality of audience members, the first question being received by the client platform at 206, receiving at least one response over the connection, the response responsive to the emitting a first question at 208, aggregating at least the at least one response into aggregated data at 210, and displaying at least a first view comprised of at least the aggregated data at 212. In some embodiments, the method may optionally include emitting a second question responsive to at least the aggregated data displayed by the analytics view at 214.

In some embodiments, providing a plurality of audience members with a client platform at 202 may include the audience members connecting to a network host using a computing device. The computing device may load a web front-end as a web page, or the computing device may download client software configured for communicating with the network host. The computing device may include a smartphone, a tablet PC, a laptop computer, a desktop computer, a video game console, or any other device facilitating a connection to a network host. The network connection may be wired or wireless. The network connection may include the Internet. In some embodiments, the network hosts to which the computing devices connect are reachable without communicating via the Internet.

In some embodiments, the client platform may receive a presentation. In different embodiments, the client platform may be configured only for receiving questions and submitting answers. In some embodiments, the client platform is an application, widget, web-page, or other similar component.

In some embodiments, the establishing a connection between the client platform and at least a first server at 204 may include the client platform operably connecting with a server, perhaps including logging in and authentication with user credentials. In some embodiments, a user may create an account pursuant to establishing a connection. In different embodiments, a user may use an existing account. In yet a different embodiment, a user may not be required to log into the server but be able to receive questions and submit answers.

In some embodiments, the emitting a first question from the at least a first server over the connection to the plurality of audience members, the first question being received by the client platform at 206 includes transmitting a question over the network to the plurality of client platforms. A user may be presented with a question in the application, widget or web-page with which the user is connected to the server. The question may be accompanied by a plurality of answers from which the user may choose one or more of the answers.

In some embodiments, the receiving at least one response over the connection, the response responsive to the emitting a first question at 208 comprises the server receiving over the network the answer choice selected or entered by the user of the client platform. In some embodiments, the data is stored, potentially with information about the users who submitted the answers (including, but not limited to, the source IP address).

In some embodiments, the aggregating at least the at least one response into aggregated data at 210 comprises creating analytics directed to the question having been emitted. In some embodiments, the aggregated data can be sorted by source IP, or by geography based upon a source IP lookup.

In some embodiments, the displaying at least a first view comprised of at least the aggregated data at 212 includes providing a private dashboard for the presenter. The private dashboard may permit the presenter to pivot the data, breaking the answers down by category.

In some embodiments, the emitting a second question responsive to at least the aggregated data displayed by the analytics view at 214 comprises the presenter formulating new content or questions based upon the aggregated data displayed at 212. Method 200 may be repeated as desired for as many questions as the presenter wishes to pose, or emit, to the audience. Each question and its responses provide another axis for analyzing or pivoting the aggregated data that is aggregated at 210. A presenter may decide to alter the presentation, or to ask a question that elaborates on a past question.

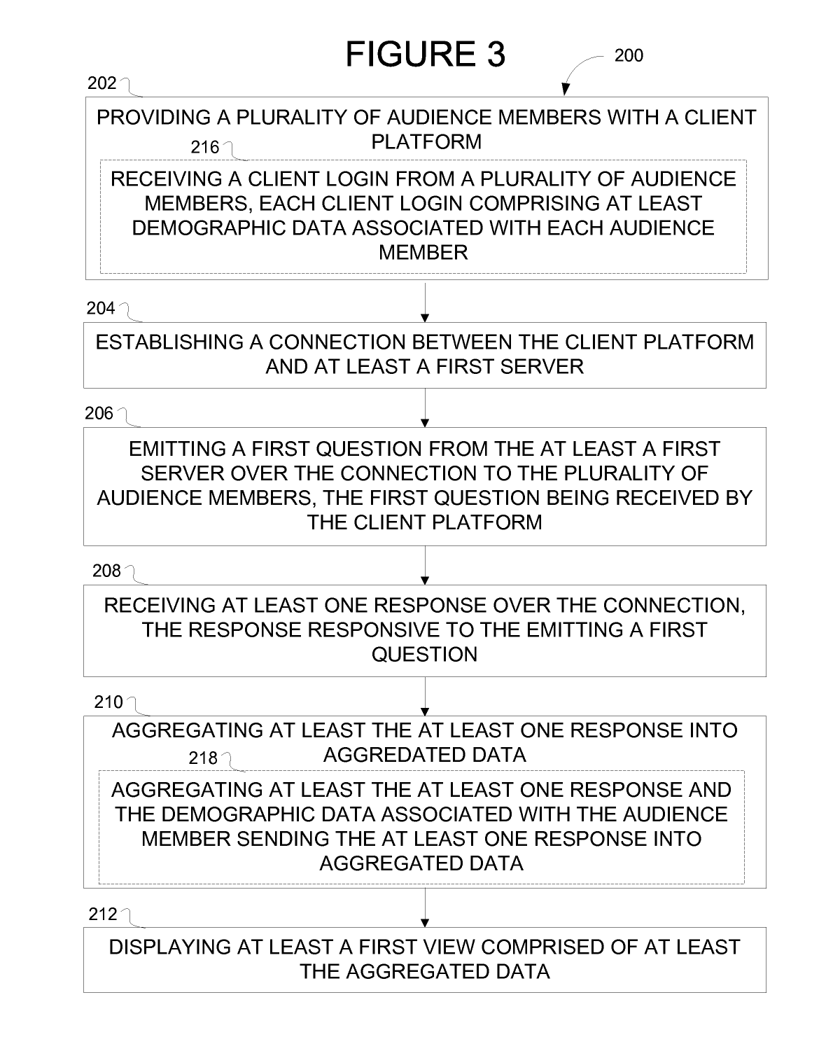

FIG. 3 is a flow diagram depicting alternative embodiments of a method for real-time and discrete analytics for web-mediated content and events. In some embodiments, operation 202 has an optional step 216, comprising receiving a client login from a plurality of audience members, each client login comprising at least demographic data associated with each audience member. In some embodiments, operation 210 has an optional step 218, comprising aggregating at least the at least one response and the demographic data associated with the audience member sending the at least one response into aggregated data.

In some embodiments, receiving a client login from a plurality of audience members, each client login comprising at least demographic data associated with each audience member at 216 includes receiving geographic data from the audience member. In other embodiments, receiving a client login from a plurality of audience members, each client login comprising at least demographic data associated with each audience member at 216 includes receiving gender data from the audience member. In other embodiments, receiving a client login from a plurality of audience members, each client login comprising at least demographic data associated with each audience member at 216 includes receiving income data from the audience member. In other embodiments, receiving a client login from a plurality of audience members, each client login comprising at least demographic data associated with each audience member at 216 includes receiving ethnic origin data from the audience member. In other embodiments, receiving a client login from a plurality of audience members, each client login comprising at least demographic data associated with each audience member at 216 includes any type of demographic data from the audience member.

In some embodiments, aggregating at least the at least one response and the demographic data associated with the audience member sending the at least one response into aggregated data at 218 includes aggregating the demographic data for each response received, separating each demographic category. In some embodiments, when the resultant view of the aggregated data is displayed at 212, the data may be pivoted, filtered, summarized, or otherwise analyzed by demographic category.

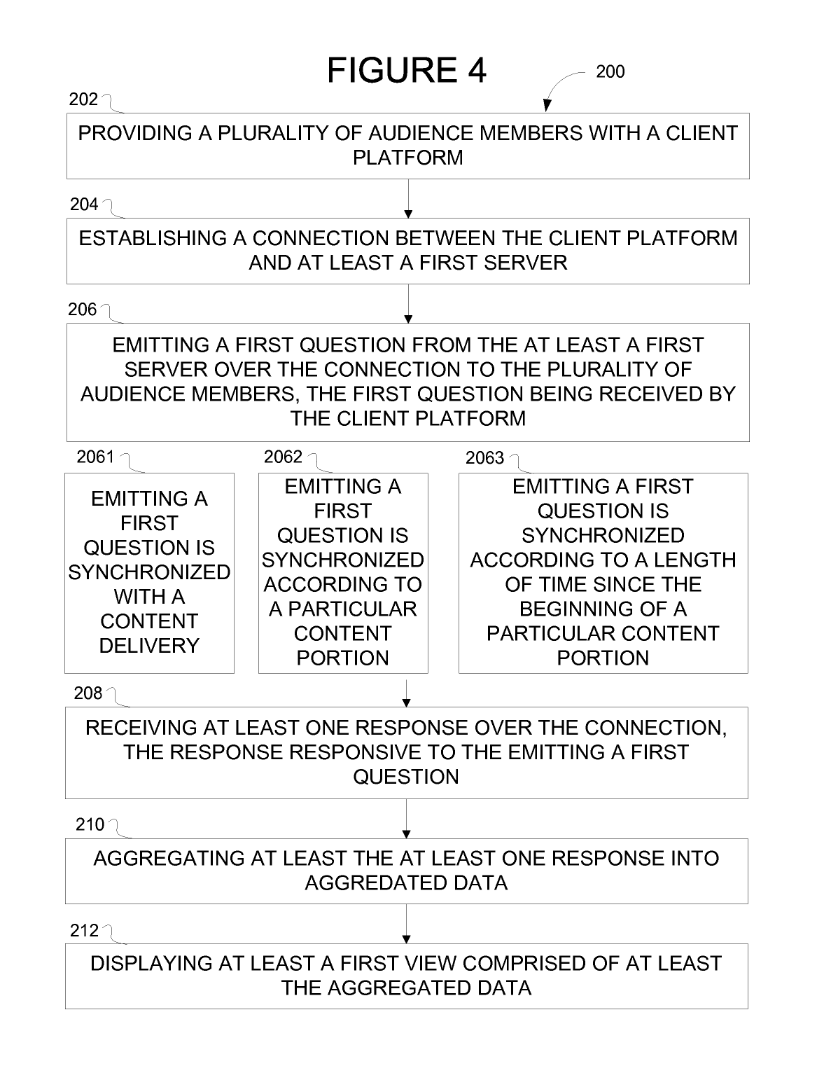

FIG. 4 is a flow diagram depicting alternative embodiments of a method for real-time and discrete analytics for web-mediated content and events. In some embodiments, operation 206 has optional embodiments including a step 2061 of emitting a first question is synchronized with a content-delivery, a step 2062 of emitting a first question is synchronized according to a particular content portion, and a step 2063 of emitting a first question is synchronized according to a length of time since the beginning of a particular content portion.

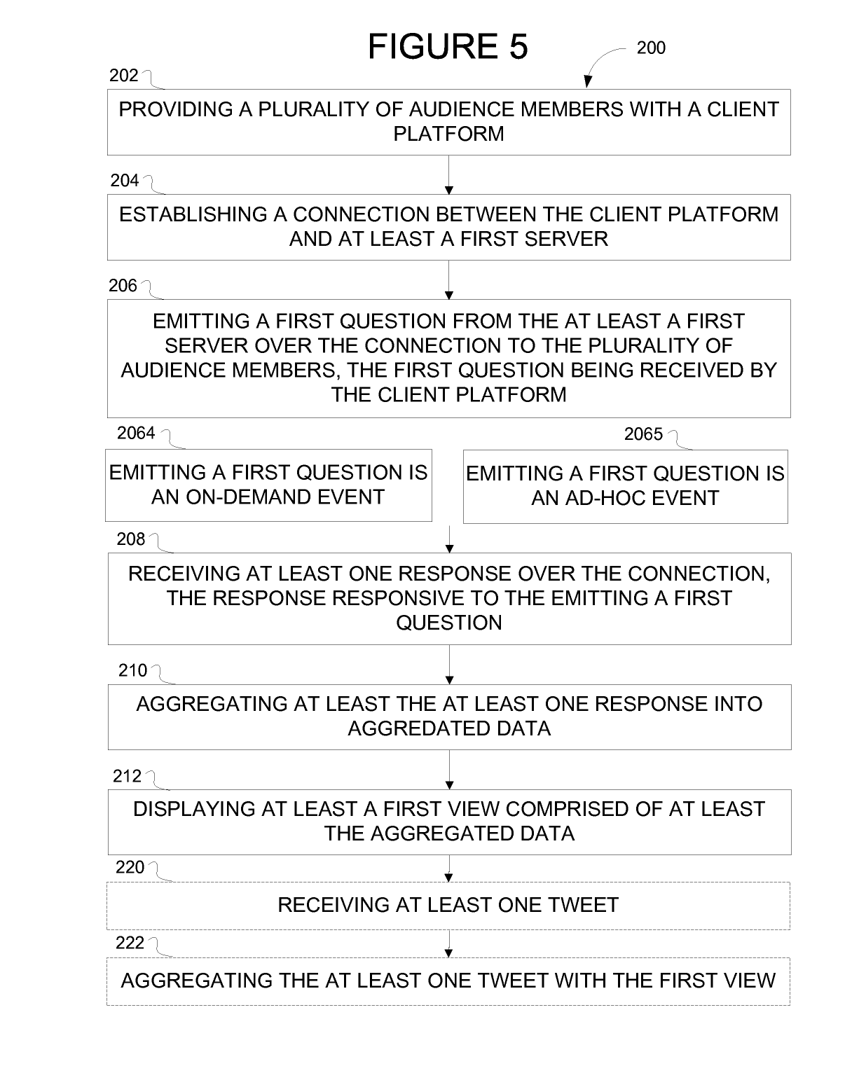

In some embodiments, a presenter who plans to present content may create one or more questions to be emitted during the presentation of the content. In some embodiments, such as emitting a first question is synchronized with a content-delivery at 2061, the questions are synchronized in advance with the content so that they are emitted at certain points during the content. In other embodiments, such as emitting a first question is synchronized according to a particular content portion at 2062, a question may be tagged to be emitted during a particular slide of a PowerPoint presentation, or when a video stream is switched from a studio location to an exterior location. In other embodiments, such as emitting a first question is synchronized according to a length of time since the beginning of a particular content portion at 2063, a question may be tagged to be emitted at a particular time during the presentation, the particular time measured as the length of time since a portion of the presentation began. A duration could also be specified, such that the question is only available for a certain length of time. As can be seen in FIG. 5, in some embodiments, such as emitting a first question is an on-demand event at 2064, a question may be emitted when the presenter feels would be the best time to push a particular pre-determined question to the audience. As can be seen in FIG. 5, in some embodiments, such as emitting a first question is an ad-hoc event at 2065, a question may be emitted if a presenter wants to create a new question on-the-fly during the presentation in response to how the delivery is going.

In some embodiments, the emitting of the questions is managed by the presenter. In different embodiments, the emitting of the questions is managed by an assistant or other third-party, who may or may not be affiliated with the presenter.

FIG. 5 is a flow diagram depicting alternative embodiments of a method for real-time and discrete analytics for web-mediated content and events. In some embodiments, operation 206 has optional embodiments including a step 2064 of emitting a first question is an on-demand event, and a step 2065 of emitting a first question is an ad-hoc event. In some embodiments, operation 212 is followed by an optional step 220 of receiving at least on tweet, and an optional step of aggregating the at least one tweet with the at least a first view.

In some embodiments, the method further includes receiving at least one tweet at 220. In addition to emitting questions which may be acted upon by audience members, those members who also have Twitter accounts may also choose to send feedback via Twitter. Such freeform text responses may be received by the servers and stored along with the responses to the questions. At operation 222 of aggregating the at least one tweet with the at least a first view, the incoming Twitter stream may be displayed on the presenter's private dashboard.

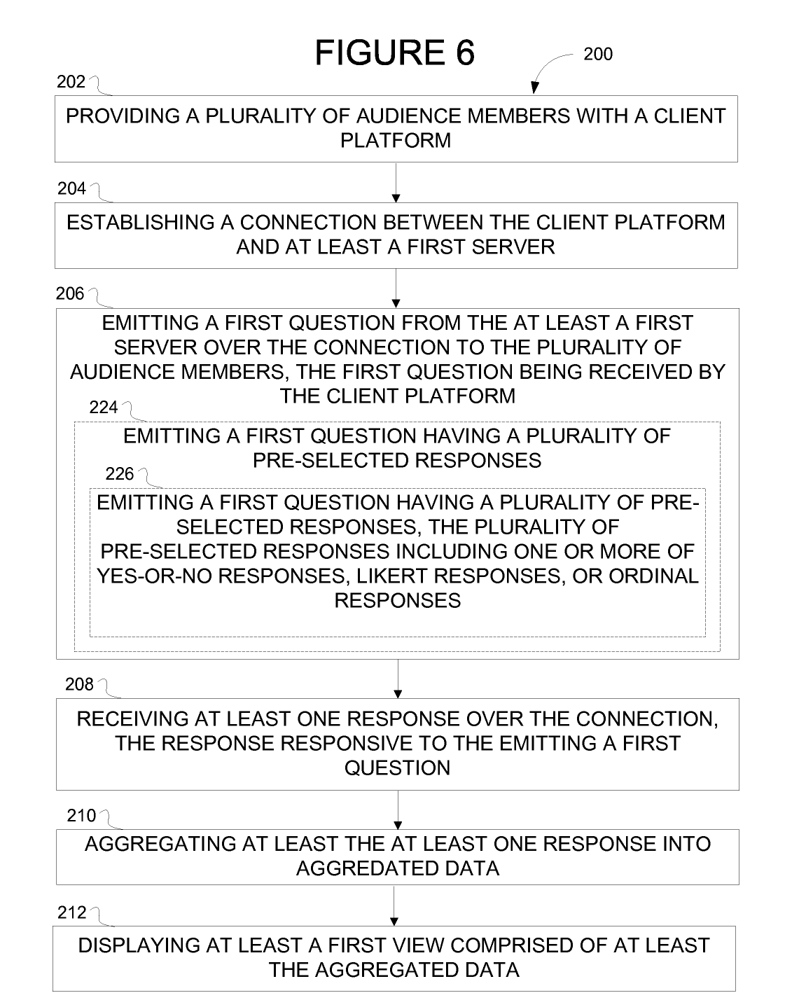

FIG. 6 is a flow diagram depicting alternative embodiments of a method for real-time and discrete analytics for web-mediated content and events. In some embodiments, operation 206 may have an optional step 224 of emitting a first question having a plurality of pre-selected responses. In some embodiments, operation 224 may have an optional step 226 of the plurality of pre-selected responses includes one or more of yes-or-no responses, likert responses, or ordinal responses.

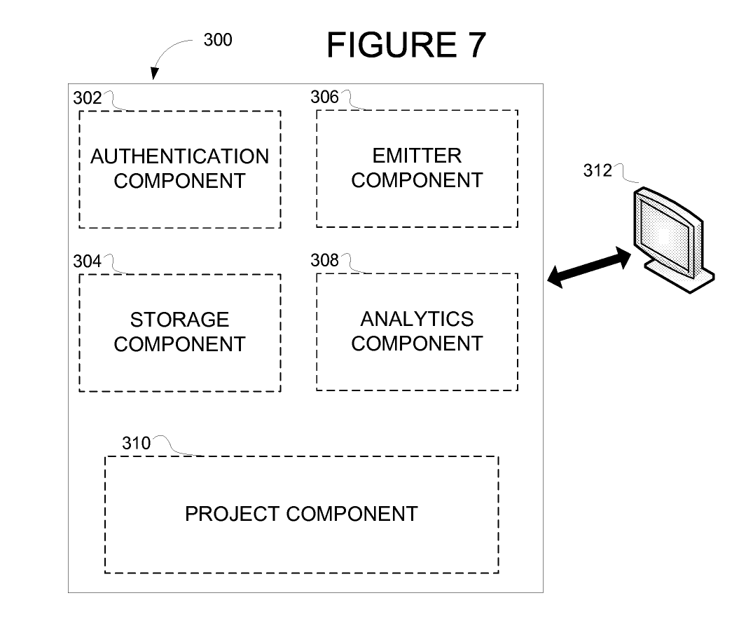

FIG. 7 is a block diagram of a system for real-time and discrete analytics for web-mediated content and events, in accordance with an embodiment of the invention. In some embodiments, a system 300 for real-time and discrete analytics for web-mediated content and events may include an authentication component 302, a storage component 304, an emitter component 306, an analytics component 308, and a display 312. In some embodiments, the system may have an optional project component 310.

In some embodiments, the authentication component 302 may comprise the means for users of client devices to connect with the system 300. The connections may in fact be unauthenticated, where a plurality of audience members make connections with the system to answer questions without providing their identities. Or, the connections may be authenticated, where audience members use a client device to create a new account (providing demographic data desired and/or required by the presenter or operator of the system 300), or log into an existing account.

In some embodiments, the storage component 304 may comprise various data stores for authentication information, presentation information, question information, response information, aggregated data sets, analytics, or other data stored in conjunction with the system 300.

In some embodiments, the emitter component 306 may comprise a means for a presenter or other operator of the system 300 to emit a question which will be received by the client devices. The emitter component 306 may also receive and validate answers from the client devices, and provide the answers to the storage component.

In some embodiments, the analytics component 308 may provide a private dashboard which is displayed on the display 312. In some embodiments, the analytics component provides a means for the presenter or other operator of the system 300 to analyze, sort, filter, correlate, pivot, or otherwise manipulate the answers, demographic data, Tweets, or other data maintained by the storage component. The presenter may use information from the analytics component to modify or create subsequent content and/or questions.

In some embodiments, the project component at 310 provides a means for users of the system 300 to create a project file including a presentation and a plurality of questions to be emitted at certain times during the presentation. The project component may include a separate authentication component which may be used to authenticate users of the project component, which may be distinct from the users of the client devices who view the presentations.

While preferred and alternative embodiments of the invention have been illustrated and described, as noted above, many changes can be made without departing from the spirit and scope of the invention. Accordingly, the scope of the invention is not limited by the disclosure of these preferred and alternate embodiments. Instead, the invention should be determined entirely by reference to the claims that follow.

What is claimed is:

1. A method for generation of real-time analytics of audience sentiment, the method comprising the steps of:
providing a plurality of audience members with a client platform;
establishing a connection between the client platform and at least a first server;
emitting a first question from the at least a first server over the connection to the plurality of audience members, the first question being received by the client platform;
receiving at least one response over the connection, the response responsive to the emitting a first question;
aggregating at least the at least one response into aggregated data; and
displaying at least a first view comprised of at least the aggregated data.

2. The method of claim 1 further comprising:
emitting a second question responsive to at least the aggregated data displayed by the analytics view.

3. The method of claim 1, wherein the providing a plurality of audience members with a client platform comprises:
receiving a client login from a plurality of audience members, each client login comprising at least demographic data associated with each audience member.

4. The method of claim 3, wherein the aggregating at least the at least one response into aggregated data comprises:
aggregating at least the at least one response and the demographic data associated with the audience member sending the at least one response into aggregated data.

5. The method of claim 1, wherein the emitting a first question is synchronized with a content-delivery.

6. The method of claim 5, wherein the emitting a first question is synchronized according to a particular content portion.

7. The method of claim 5, wherein the emitting a first question is synchronized according to a length of time since the beginning of a particular content portion.

8. The method of claim 5, wherein the emitting a first question is an on-demand event.

9. The method of claim 1, wherein the emitting a first question is an ad-hoc event.

10. The method of claim 1, further comprising:
receiving at least one tweet; and
aggregating the at least one tweet with the at least a first view.

11. The method of claim 1, wherein the emitting a first question includes emitting a first question having a plurality of pre-selected responses.

12. The method of claim 11, wherein the plurality of pre-selected responses includes one or more of yes-or-no responses, likert responses, or ordinal responses.

13. A system for generation of real-time analytics of audience sentiment, the system comprising:
an authentication component;
a storage component;
an emitter component;
an analytics component; and
a display.

14. The system of claim 13, further comprising:
a project component.
